(19) United States
(12) Patent Application Publication
(10) Pub. No.: US 2025/0335324 A1
(43) Pub. Date: Oct. 30, 2025

(54) Proxy Training Data for Cold-Start Continuing Text Optimization

(71) Applicant: Stodge Inc., Scottsdale, AZ (US)

(72) Inventor: Christine Donnelly, Whitefish, MT (US)

(21) Appl. No.: 19/193,928

(22) Filed: Apr. 29, 2025

Related U.S. Application Data
(60) Provisional application No. 63/640,182, filed on Apr. 29, 2024.
(60) Provisional application No. 63/674,791, filed on Jul. 23, 2024.

(51) Int. Cl. G06F 11/34

(52) U.S. Cl. CPC G06F 11/3414

(57) ABSTRACT

Methods, systems, and apparatus, including computer programs encoded on computer storage media, for more efficiently configuring a policy model to generate candidate messages. One of the methods includes prompting a policy model to generate candidate messages for new content being introduced to the system in reference to a control message associated with the new content. A reward model predict a performance of at least one of the candidate messages for the new content against the control message associated with the new content. The candidate messages are tested to obtain actual relative preference data obtained from engagements with the candidates messages being tested. The phantom relative preference data are supplemented with real relative preference data. Candidate messages are selected to send as continuing text.

### CROSS-REFERENCE TO RELATED APPLICATIONS

This application claims the benefit under 35 U.S.C. § 119 (e) of the filing dates of U.S. Patent Applications No. 63/640,182, titled “Human Feedback Proxy for Generative AI Text Optimization,” filed on Apr. 29, 2024, and U.S. Patent Application No. 63/674,791, titled “Human Feedback Proxy for Generative AI Text Optimization,” filed on Jul. 23, 2024, both of which are incorporated by reference in their entirety.

### BACKGROUND

In the field of computing, transformer-based machine learning models have revolutionized information retrieval. Where human users had to read through search results returned by a search engine of a corpus of documents to obtain information of interest, this information can now be programmatically inferred or otherwise synthesized from the search results. Information retrieval (“IR”) systems can, for example, directly answer a particular question of a query in addition to providing search results responsive to the query.

Depending on the extent of the corpus and the size of the documents, required computing resources for information syntheses can be prohibitive and impractical. Context data can easily exceed model limitations, for example. Even when limitations are not exceeded, superfluous data processing can be wasteful and introduce unreliable information syntheses. Moreover, latency may be problematic, especially where the IR system implements a user interface that leverages resources for generating continuing texts, including those that are responsive to queries submitted by human users (e.g., artificial intelligence or “AI” powered chatbots). Such a user interface can supplement search results and/or function as an alternative. In the latter case, the human user can bypass reading classic search snippets and results all together and obtain the information of interest by interacting, via the user interface, with computing resources that generate continuing texts. In some cases, the continuing texts are generated in response to algorithmic determination of user interest, rather than responsive to receipt of query submission. Examples here include a push notification that a topic of interest on a social media platform, a news platform, and/or a retail platform is trending and/or available for consumption.

Generally speaking, continuing text is a generative AI computing task that programmatically provokes or initiates conversations and/or programmatically generates the next communication in the conversation, where human users are participants. Communication can take the form of audio or text, e.g., SMS messages, chats (in application or otherwise), emails, as well as any other short or long form messages. Conversations typically include one or more topics of interest included in the corpora of the IR system, which topics can be, for example, real-world events (current and/or historical), academic and research publications, products sold by merchants, marketing and sales, trouble shooting from expert systems, and/or customer support for businesses, financial analyses, and so forth.

### SUMMARY

A system in accordance with aspects of the invention includes one or more of the following: (i) a large language model, referred to here as a policy model, that generates continuing texts for one or more specific tasks, where the generated continuing texts are policy compliant, and (ii) a reward model that predicts the success of the continuing texts at achieving their assigned tasks, under the constraint that they are policy compliant. Here, specific tasks can include provoking content engagement, for example, and being policy compliant generally can mean the continuing texts generated are consistent with constraints imposed for the specific tasks, usually by the task assigner. A content creator seeking to provoke human user engagement with content, for example, can require that the continuing text generated inspire positive sentiment from the human user and be context appropriate, as perceived by the human user. (Specific continuing-text tasks and policy compliance are further described below.)

Notably, the policy model can generate continuing texts that are compliant with both policies of content creators and policies of the target audiences of content (e.g., be personalized to the audience's individual preferences). Both types of policies can be directly provided to the system, as well as inferred by the system from the content and related engagements.

Notably, the reward model can predict not only the policy models' performance at generating continuing texts that achieves assigned tasks, it can further predict the policy model's performance with generating continuing texts that are also policy compliant, including being policy compliant for the target audience. Predictions and assessments of success by the system's reward model can be based on relative preference data, which generally is actual engagement data that indicates or suggests, directly and/or indirectly, a preference of one continuing text over one or more other continuing texts, and which can serve as a suitable proxy for surveys (for example, those that provide two or more continuing texts being assessed and asks human users for their preferences and how they feel about them, whether they are on brand, in context, and inspired positive sentiments, etc.). The relative preference data advantageously provides more reliable and trustworthy data for training the system's reward model (as human users can respond inaccurately or dishonestly and hence survey results can be unreliable and untrustworthy), and which furthermore advantageously enables programmatic and quicker implementation, as surveys can require human review and take much longer to complete than the time required to collect relative engagement data sufficient to ensure adequate model performance.

Therefore, the techniques described in this specification provide a specific solution to the technological problem of acquiring a sufficient amount of reliable training data and quickly enough to be useful to leverage large scale machine learning models to perform real-world applications. Using the techniques described in this specification allows the system to tune the reward model orders of magnitude faster than prior approaches, while also using higher quality data.

Moreover, the system has resources and implements strategies that advantageously address cold-start problems, especially those imposed on its reward model. For example, when the system is tasked to generate and assess continuing texts for a new corpus from a new content creator, for which new corpus the system has no engagement data, including relative preference data, the system need not wait the conventional period to collect engagement data from human engagement with the new corpus. Rather, the system can leverage prompt tuning to task its policy model to generate continuing texts that are both suitably successful at the tasks assigned by the content creator and at being compliant with policy imposed by the content creator. The system can further leverage previously obtained and processed relative preference data from its former corpora (before the addition of the new corpora) to initialize its reward model to predict satisfactorily the success of continuing texts generated by the policy model for the new corpus and corresponding task. While reward-model performance is far from perfect compared to having a bounty of engagement data collected over conventional training periods, it is actually sufficient essentially right off the bat (e.g., a few days) for many continuing text specific tasks, especially when the previous engagement data is supplemented with one or more feedback loops based on selected reward metrics, a subset of relative preference data, as described further below. The insight here is that significantly less than optimal model performance is required in order for the system to achieve a target success rate for the newly assigned tasks, under the constraint of corresponding policies, of the newly added corpus, and the system's feedback loop based on reward metrics is more than sufficient to compensate for performance degradation caused by cold starts.

Accordingly, the techniques described in this specification solve the technological problem of cold start initialization by providing for a vastly more efficient start-up process that bypasses the typically long initialization process for new models. This in turn makes the system more scalable because an unbounded number of ready-to-perform models can be scaled up quickly without the need to also proportionally scale up the amount of initialization data that needs to be collected.

To expound on the above, the policy model of the system can be a generally trained model that is further trained and/or tuned to generate continuing text for one or more particular subject matters of interest and that, for example, (i) motivates a higher rate of positive business outcomes, which is one example of an assigned specific task for the continuing text, (ii) has positive sentiment, and (iii) is context appropriate for a given conversation. The latter two items are examples of policies imposed along with the assigned task.

Positive business outcomes, in one case, means that the continuing texts motivate customers receiving the messages to engage (e.g., consume content, engage with content, click on links, purchase or subscribe, etc.) at a higher rate than would have occurred otherwise (e.g., in comparison to a control continuing text, which can be human generated, and which can provide a baseline). The higher engagement with content can lead to higher traffic and/or revenue earned for the business sending the message. Generally speaking, positive sentiment means that the continuing text would be considered brand-appropriate by the business or other content creator sending the text message. Note that being brand appropriate is not the same as being brand safe. The latter generally deals with NSFW, toxicity, as well as other offensive infelicities. The former relates more to the style, culture, and/or persona of a brand of a business, for example, contemporaneous cultures and styles that are embraced by the brand and its target audience. Positive sentiment also means the continuing text was well received by the business' customers or other target audience. They come out of the conversation with a positive sentiment, for example, regardless of whether they subscribed or purchased content and corresponding products and services. Being context appropriate generally means that the continuing text is within scope of the one or more topics of a conversation or communication. (Given the subjective nature of the issues here, whether continuing text is successful at achieving these goals and the degree to which they are successful are conventionally judged by human participants, typically via surveys and the like that ask for preferences and sentiments about the continuing texts in question, which responses are then used to generate labelled training data, as mentioned above.)

The training of system models leverages reinforcement learning from human feedback (“RLHF”). In the context of the policy model, RLHF resources of the system include the reward model, which can be trained on engagement data, including relative preference data (in addition to or in lieu of surveys) to predict the relative quality of a prompt mechanism to the policy model and the corresponding one or more continuing texts generated with the prompt mechanism (which generally controls the content included in and the order of the included content in a prompt). The reward model's predictions can be used to update the policy model weights and/or the prompt mechanism in order to improve performance.

With respect to the reward model, RLFH resources of the system include the available relative preference data. Especially helpful relative preference data are reward metrics (or positive outcomes of an engagement with continuing text), which provide suitable and reliable relative preference data. Generally speaking, reward metrics are related directly or indirectly to various tasks, including those described above. A specific task assigned to a continuing text that is a push notification, for example, can be to increase content subscription and the corresponding business goal is to increase traffic and revenue. Here, the reward metrics can include any combination of the following: the act of subscribing to content; service and/or product purchase; impressions and other forms of ads conversion; a long click on links included in the continuing text; a conversation with a human user caused by the response to the continuing text, increased traffic and/or revenue corresponding to a time when the continuing text was used, etc. Optionally, reward metrics can be generated from the system's engagement logs and/or from real-time (or near real-time) engagement data.

Notably, reward metrics are not equally effective as signals of relative preference data. Depending on the task, some have proven to be significantly more reliable than others. For content subscription, for example, completed subscriptions are much more reliable than a link click on or an impression of the continuing text under consideration.

Moreover, reward metrics can indicate not only success at achieving tasks assigned to continuing texts, but also success at policy compliance. One is generally less likely to subscribe to content, for example, if the continuing text is off-putting and/or not brand appropriate. For marketing and sales, examples of success metrics include a purchase, a subscription, or other conversions for which advertisers would credit causation. In many of these cases, success metrics are representative of human perception of positive sentiment and context appropriateness, mostly because the target audiences (merchants and shoppers) are unlikely to approve and/or engage with continuing texts otherwise. For merchants, decision makers (in customer support, Comms, Marketing, Sales, etc.) would not usually approve off-brand messages, which would preclude downstream conversions because these continuing text would not be sent at all and/or would be pulled after some have been sent. Shoppers would not likely engage with text messages that are off putting, e.g., because they are out of context or they do not inspire positive sentiment. Significant experimentation has demonstrated strong correlation between success metrics and both continuing task completion and human perception of sentiment and context. Importantly, the system is able to sustain well merchant's policies in its generation of continuing texts, even over time periods when changes to operational data typically occur that would degrade sustainability, while improving positive business outcomes. Advantageously, the use of success metrics mitigates significant problems that accompany conventional surveys, notably costs and delays that come with obtaining sufficient sample size, and changes in human preferences over time between surveys and over regions and demographics not covered by surveys.

Optionally, the system's prompt mechanism leverages a control or baseline continuing text. Specifically, the prompt mechanism generates a prompt that instructs the policy model to generate a continuing text for a specific task and includes, in the prompt, the control continuing text for reference, along with other context information (which can include, for example, model policies and other context information such as selected documents from the corpus of interest, as well as insights, observations, and strategies derived from engagement data). The control continuing text is also provided to the system's reward model, which predicts how well the continuing texts generated by the policy model would perform vis-a-vis the control continuing text. The control continuing text can also be sent to human users during sessions to collect relative preference data, including reward metrics. (Details of these sessions are provided below.)

When the system executes more than one session with human users to collect relative preference data (e.g., an experiment session to send the generated continuing texts to a limited number of human users), the control continuing text can be used to normalize relative preference data across the sessions, especially useful when the sessions are conducted across different circumstances that introduce error into the data. Here, the control continuing text acts like LSAT or state bar questions that are used across multiple exams to normalize variances in test taking conditions. The normalized relative preference data advantageously stabilizes the reward model's performance over time and across regions.

Optionally, to reduce the frequency of training of its policy model, which adjusts parameter weights and which can be computationally expensive, the system includes in its prompt mechanism an exemplary continuing text and updates it when data indicates that operational data has outgrown training data such that policy model performance has degraded significantly. For example, when reward model output consistently predicts that the continuing texts generated by the system's policy model would perform worse than the control (baseline) continuing text, then the system can update the exemplary continuing text based on relative preference data, including reward metrics. This technique advantageously reduces the frequency of needed training of the policy model.

In general, in one aspect, a system for generating continuing texts, comprises a policy model configured to generate one or more candidate messages, given a baseline message and corresponding policies, wherein the candidate messages are generated under constraints imposed by the policy. The system further comprises a reward model trained to predict a performance of the candidate messages generated by the policy model relative to the control message, wherein training is accomplished with relative engagement data. The system further comprises one or more servers having tangibly-stored instructions executable to prompt the policy model to generate candidate messages for new content being introduced to the system in reference to a control message associated with the new content, wherein the system has yet to obtain relative preference data associated with the new content, and wherein the reward model has not been trained with relative preference data associated with the new content. The instructions are further executable to cause the reward model to predict a performance of at least one of the candidate messages for the new content against the control message associated with the new content and concocting phantom relative preference data that are based on the predicted performance. The instructions are further executable to test the candidate messages to obtain actual relative preference data obtained from human user engagements with the candidates messages being tested. The instructions are further executable to supplement the phantom relative preference data with real relative preference data. The instructions are further executable to select candidate messages to send as continuing text, whereby reward model performance is sufficiently improved with the real relative preference data to compensate for its lack of training with relative preference data associated with the new content such that the selected candidate message is more likely than not to out perform the control message.

In general, in another aspect, the policy model is trained with relative preference data, and wherein the relative preference data is a suitable proxy for survey data and is used in lieu of survey data.

In general, in another aspect, the instructions are further executable to prompt a transformer-based machine learning model to generate a prompt for input to the policy model, wherein the prompt causes the policy model to generate candidate messages.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows a system 100 in accordance with aspects of the invention.

FIG. 2 shows example context information provided by a merchant.

FIG. 3 shows example context information generated by the system 100 based on merchant input.

FIG. 4 shows a process for generating and assessing candidate messages.

FIG. 5 shows an example of merchant input.

FIG. 6 shows an example of verbose descriptions generated by the prompt engine.

FIG. 7 an example timeline of rebalancing and full updating for an experiment.

FIG. 8 depicts a graphical representation of a probability matrix.

Like reference numbers and designations in the various drawings indicate like elements.

### DETAILED DESCRIPTION

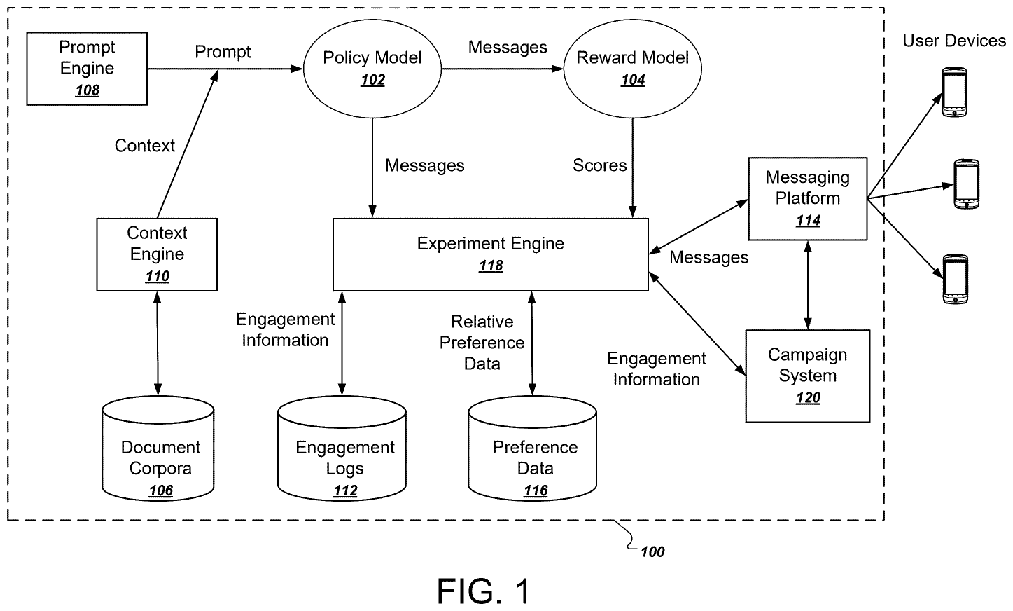

FIG. 1 shows a system 100 in accordance with aspects of the invention. The system 100 includes one or more servers that implement a policy model 102, a reward model 104, a corpora of documents 106, a prompt engine 108, a context engine 110, engagement logs 112, a messaging platform 114, a datastore of relative preference data 116, and an experiment engine 118.

Generally speaking, the policy model 102 is a generally trained and optionally tuned LLM that generates continuing text for specific tasks, under specific context, which includes policy constraints associated with respective specific tasks, as well as observations, insights, and strategies to enhance model performance, including a control continuing text. The generated continuing texts are candidate or test messages, and the control continuing text is a control or baseline message. Optionally included are exemplary continuing texts, as further described below. The reward model 104 is a machine-learning model (or, optionally, a transformer-based model that is an LLM) trained with relative preference data, including reward metrics, to predict the relative improvement of continuing text generated by the policy model (i.e., the candidate messages) over the control continuing text (i.e., the control or baseline message) and/or relative to each other. The corpora of documents 106 includes content of one or more content creators. Examples of documents include webpages, product catalogs, webpages of products, advertisements, social media content, academic publications and reference materials, as well as any other information that may be of interest to human users of the system 100. The continuing text can include and/or reference one or more documents and/or information included in the documents. Notably the corpora of documents can be created by multiple, different content creators. The prompt engine 108 generates the prompt that the system 100 uses as input to its policy model 102. Optionally, the prompt engine 108 can include a transformer-based machine learning model that can programmatically generate the prompts (not shown). The context engine 110 generates context information for inclusion in the prompt. Context information can include policies that the content creator wants to impose for a given specific continuing text task, content, products, and/or services that are available for consumption. The engagement logs 112 store raw and processed data obtained from human-user engagements with the continuing texts and documents of the corpora 106. The messaging platform 114 manages, for the system 100, sending and receiving continuing texts (control and candidate messages). The datastore of relative preference data 116 includes selected engagement data that can be raw or processed, and importantly includes success metrics. Selection is based on efficacy as a reliable signal of reward model performance. The experiment engine 118 runs experiments for the system 100 to obtain relative preference data, which in turn is used to train the reward model 104, train the policy model 102, and/or to improve the prompt engine 108.

As used in this specification, an experiment refers to a process by which candidate messages are tested live against a control message in the course of a content creator's conduct of business and commerce, e.g., customer support (which can be technical), education, marketing, sales, as well as other applications of information retrieval, etc. Experiments can be conducted in sessions or continuously in the course of business. Engagements resulting from human beings reading and otherwise engaging with the candidate messages are logged and processed. Relative preference data from a current experiment, including success metrics, is then appended to the aggregate data set used for training the reward model 104 and also for adjusting predicted performance of candidate messages that are being tested by the experiment engine 118.

In one implementation, the system 100 generates continuation SMS texts for marketing. With this implementation, the policy model 102 generates continuing texts to encourage prospective shoppers to subscribe to a merchant's marketing messages and/or to purchase the merchant's products/services. The control continuing text is a marketing message the merchant generated and has been using with a certain degree of success. The control continuing text has a baseline performance over which the merchant aims to improve with continuing texts generated by the system 100. The reward model 104 is trained to predict the relative performance of the candidate messages against the control message, a figurative “lift” in performance, which function it does well. The corpora of documents 106 include product catalogs, advertising messages, and promotions of the merchant. The prompt engine 108 generates prompts by working in conjunction with the context engine 110, which includes a brand preference engine (not shown).

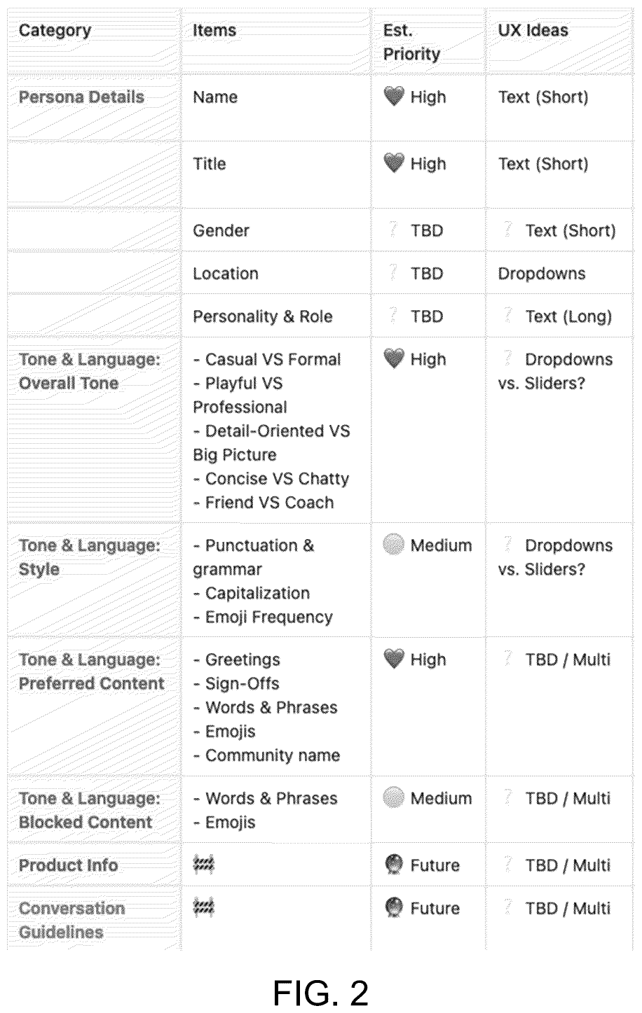

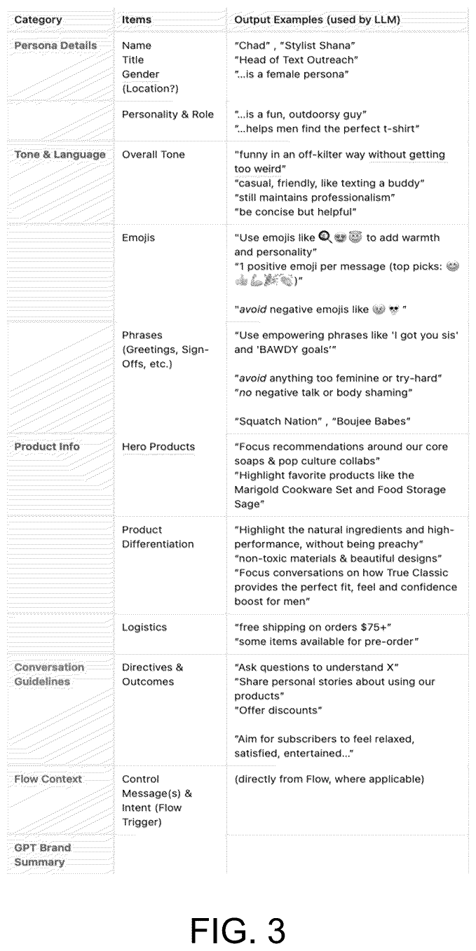

Here, a prompt generally includes a task, which can be associated with an event related to the task (e.g., generate a marketing message in response to a sale, a holiday, a shopper reaching VIP status, and/or an abandoned cart). The prompt also includes other context information associated with the tasks, as well as playbook instructions to leverage insights, observations, and strategies that have proven to be effective based on engagement data. Context information can further include a control message that the merchant has previously used or is currently using, policies of the merchant such as persona, tone, style, target audience (e.g., segments of shoppers and/or subscribers, who are shoppers who have already subscribed), and conversation guidelines. Context information can further include products and product variances selected from the corpora 106, for example, those that are on sale, included in an abandoned cart, trending, and/or highly profitable. (Product variances are possible variations of the product, examples of which include a shirt color or size.) Playbook instructions can be personal to the particular shopper based on previous conversation with the shopper. For example, the shopper demonstrated in previous engagements a preference to a certain tone of voice and being more receptive to marketing messages during a certain time of day. Playbook instructions can include exemplary messages, candidate messages that have been proven to outperform the control message by relative preference data obtained by experiments conducted by the experiment engine 118. FIG. 2 shows an example of policy input provided by the merchant. FIG. 3 shows an example policy input generated by the context engine 110 based on merchant input.

In operation, the system 100 can work in conjunction with a campaign system 100 120 that implements marketing campaigns, which is described in patent application Ser. No. 18/234,857, entitled Campaign Message Flow Builder, filed on Aug. 16, 2023, which is hereby incorporated by reference in its entirety. The messaging platform 114 can work with campaign system 100 120 or be implemented as part of campaign system 100 120 to test candidate messages proven to be more effective than the control message by including them, for example, in a live marketing campaign. The campaign system 100 120 collects and provides engagement information to experiment engine 118, which processes the engagement data to obtain relative preference data.

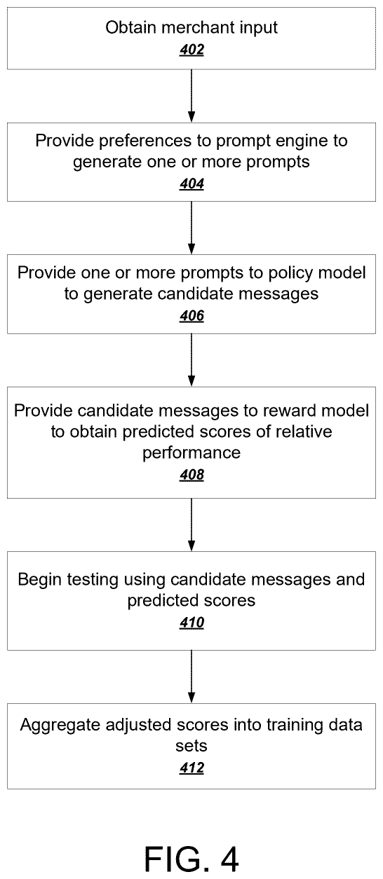

FIG. 4 shows a programmatic process that generates continuing text for marketing purposes for a particular merchant. As shown, the context engine 110 (via its brand preference engine) obtains merchant input via a website referred to as a brand center, which implements a UI through which a marketing employee of the merchant can provide policies of the merchant (step 402). The UI includes any combination of the following:
Free text box for the marketing person to describe in their own words the shop's preferences.
One or more sliders for the person to indicate the shop's preferred tone of voice.
Options for the person to define the shop's persona.
Options for preferred greetings and sign-offs.
Options for words/phrases to include and/or avoid.
Options for emojis to include and/or avoid.
Options to block texts.
Reference text of the shop (e.g., the one they have been using) for the control message.

Example inputs for shop preferences include any combination of the following:
Persona Details—name, title
Flow Context—(indirect guidance) user-defined “control/inspiration copy”
GPT Brand Summary
Brand Tone & Language
   Overall tone (“casual, friendly, texting a buddy” vs. “maintain professionalism”)
   Phrases & emojis to use/avoid
Product Info
   Hero Products: “Core soaps & pop-culture collabs” vs. “Marigold cookware set”
   Differentiation: “natural ingredients” vs. “non-toxic materials & beautiful designs”
   Logistics: “free shipping on orders $75+”; “some items available for pre-order”
Conversation Guidelines
   Directives: “Ask questions to understand X”; “offer discounts”
   Outcomes: “Aim for subscribers to feel relaxed, satisfied, entertained . . . ”

The context engine 110 provides the above preferences to the prompt engine 108 to generate one or more prompts for input to the policy model 102 (step 404). To generate the prompts, the prompt engine 108 works with a transformer-based machine learning model, which can be a generally trained LLM that is locally or remotely instantiated. The LLM synthesizes the merchant's inputted preferences and generates verbose descriptions of them. The prompts are engineered so that the LLM generates guidelines that will enable the policy model to be influenced by, but not dictated by the merchant's preferences. Hence, some of the candidate messages the policy model generates based on the guidelines will not adhere 100% to the merchant's preferences. Optionally, the generally trained LLM can be fine tuned based on relative preference data, including success metrics.

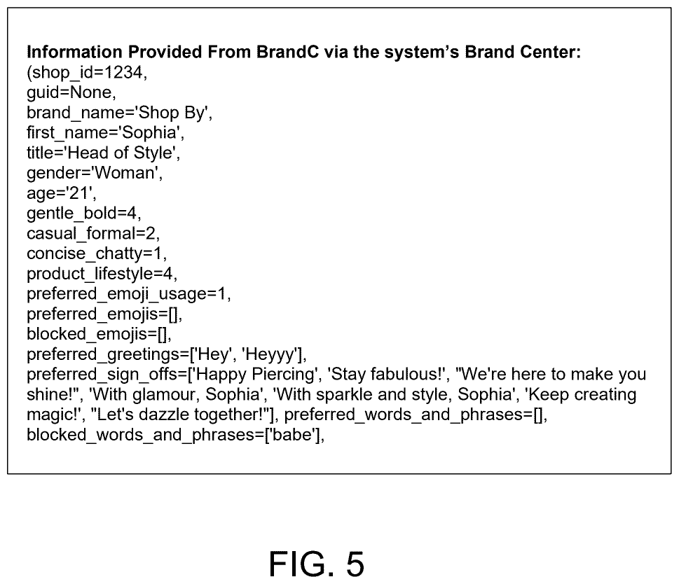

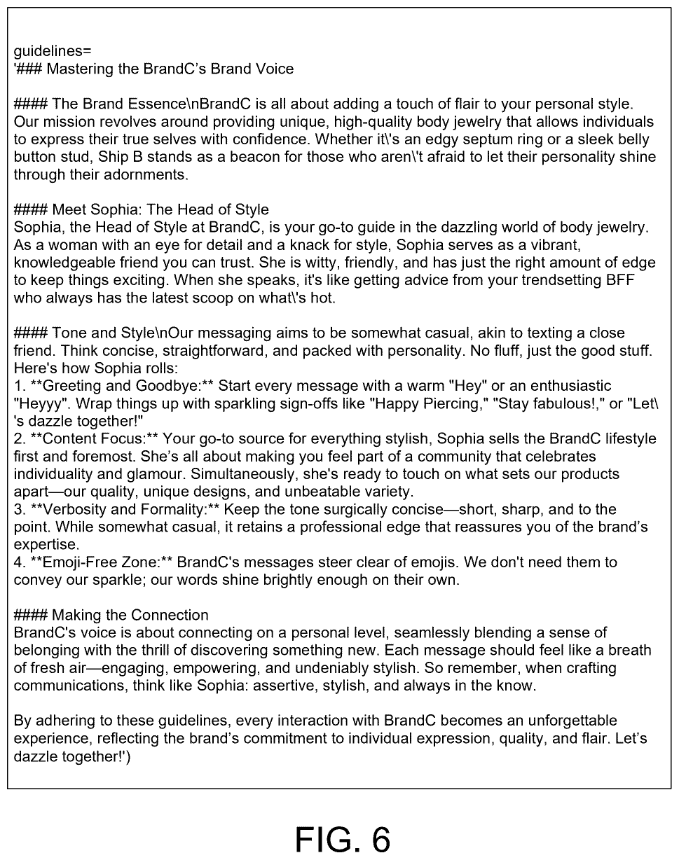

FIG. 5 shows an example of merchant input, where the merchant is called Brand C and sells body jewelry, e.g., nose rings, belly rings, and tongue rings. FIG. 6 shows an example of verbose descriptions generated by the prompt engine 108 based on this particular merchant's input shown in FIG. 5.

The prompt generated by the prompt engine 108, which prompt includes the verbose description generated by the context engine 110, is then inputted to the policy model 102, which generates 50-100 candidate messages (step 406). More or fewer candidate messages can be generated, depending on the tasks assigned to continuing text and the particular context under which the task is to be performed.

Optionally, the system 100 generates and runs a variety of prompts that ask for different “rewrite strategies” in the policy model, and also runs the policy model at a temperature of 0.8 to 1. For example, the prompt engine 108 can generate two prompts for a given continuing text and task, resulting in candidate texts to be tested that are generated by two rather than one prompt. Both of these actions are done for the purpose of introducing more variety into the continuing text messages that are generated. (Model temperature is a parameter that influences randomness in its output to range from being predictable to being random and creative.)

The candidate messages are provided to the reward model 104, which computes predictive scores for each candidate message indicating its relative performance compared to the control message, as well as all of the other candidate messages (step 408). The experiment engine 118 prunes candidate messages that are below a threshold score, e.g., where there is high confidence that the candidate messages would perform significantly worse than others messages being tested, including the control message and any exemplary messages. After pruning, there are typically 25-70 test messages. Candidate messages that scored significantly higher than exemplary messages can optionally be prioritized over other candidate messages by being allocated a higher share of the marketing traffic (e.g., such a candidate message can have an allocation greater than its pro rata allocation of marketing message traffic). Optionally, the number of candidate messages to be tested in an experiment can be based on anticipated data volume. Linear regression between 20 conversions per day and fewer than one conversion per day (but more than zero) provides a suitable basis to determine this number.

Given the lists of candidate messages and scores, the experiment engine 118 begins testing (step 410). Initially, the experiment engine sends out candidate messages in accordance with their scores. A candidate message having a score of 0.3, for example, will be sent 30% of the time. Alternative message traffic allocation includes an allocation based on weighted scores and a pro rata allocation. The former approach is more suitable when there is high confidence in predictions of the reward model 104, and the latter approach is more suitable when confidence in predictions of the reward model is low (e.g., when the reward model has not been trained on relative preference data for a merchant and has to rely on those of other merchants, i.e., a cold-start situation). One example of traffic allocation includes one in which the control message is sent 50% of the time and the candidate messages are sent the other 50% of the time, the share of which depending on their scores. Figuratively speaking, the initial traffic allocation is based on the system's best guess as to how candidate messages will perform. Dynamic and constant adjustments (or rebalancing) are then made based on a feedback loop of selected relative preference data, which can be success metrics.

Adjustments are based on detection of a threshold success, and the experiment engine 118 changes the initial scores of candidate messages (i.e., the scores computed by the reward engine 104) ONLY when there is a threshold number of success metrics (or positive outcomes) for a candidate message under consideration. Success metric can be a sale, subscription, and/or another advertising conversion. Conversions distinguish candidate messages from each other (e.g., the better ones will yield more conversions, and the poor performing ones will have fewer or no conversions). Since it is important to have a sufficient sample size to overcome statistical noise, there must be a threshold number of success metrics before changes are made to the initial scores of the test messages.

Notably, experiment management occurs periodically, but only when a certain data threshold is reached. This requirement prevents the experiment engine 118 from taking action prematurely, before there has been a chance to learn anything from the current experiment, which is a problem that tends to plague small volume merchants.

Generally speaking, experiment management performed by the experiment engine 118 includes adjusting scores predicted by the reward model 104, rebalancing allocation of traffic of candidate messages based on adjusted scores, removing candidate messages that have under performed, and obtaining from the policy model 102 new candidate messages to replace the candidate message that have been removed from the experiment.

Rebalancing in some instances occurs at most every 24 hours and only happens if the candidate messages are showing less than 60% chance of beating the control message since the last rebalancing. Rebalancing requires at least 10 positive outcomes since the last rebalancing. Rebalancing only reallocates message traffic toward higher performing candidate messages and away from lower performing ones and, notably, continues testing the same candidate messages.

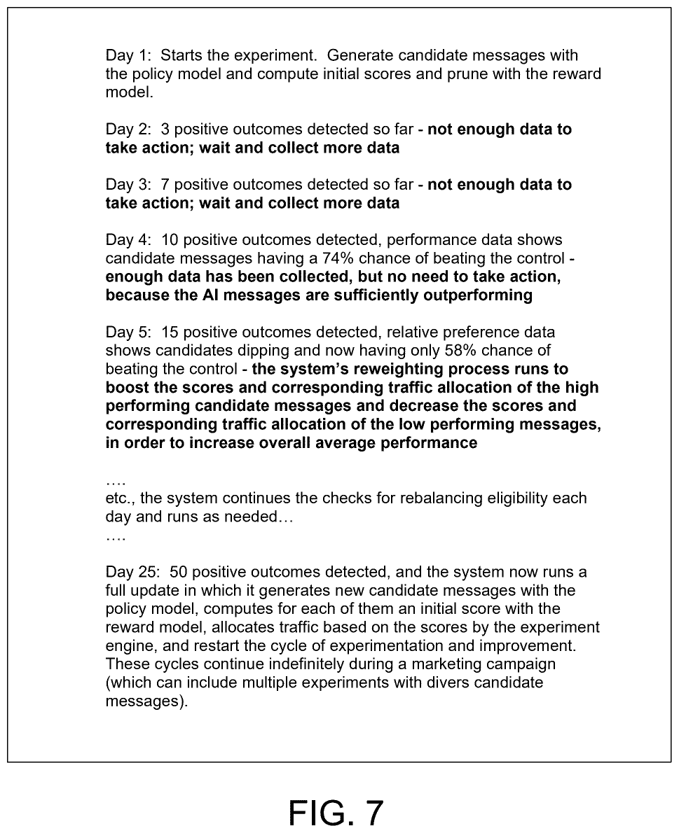

Full updates, which includes both (i) rescoring as well as (ii) removing and replacing candidate messages, can occur at most every 7 days. A full update requires at least 50 positive outcomes since the last full update, so it might need to wait much longer than 7 days to meet that threshold for small volume merchants (which tend to have fewer engagement than large volume merchants). In this case, the experiment engine 118 has done enough testing of older messages and is ready to start testing new ones. See FIG. 7 for an example timeline of rebalancing and full updating for an experiment.

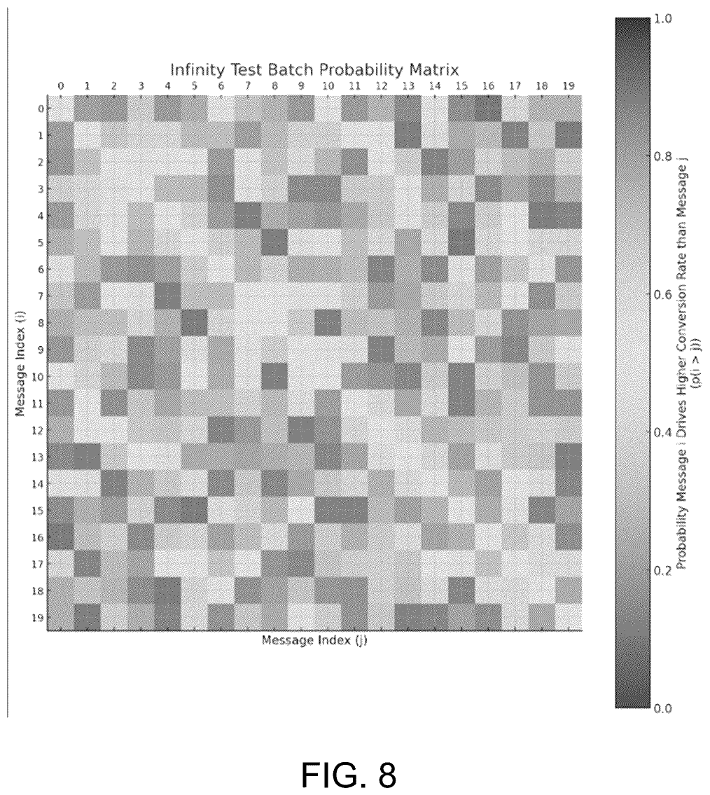

FIG. 8 depicts a graphical representation of a score (or probability) matrix generated from predictions made by the reward model 104 for a given experiment. The degree of shading of each square (i,j) represents the probability that message index “i” drives a higher conversion rate than message index “j” for the experiment. More red shading indicates higher probability, and more blue shading indicates lower probability. Initially the probability is determined by the scores of the reward model. As sufficient relative performed data is obtained, the experiment engine 118 updates the matrix. At completion of an experiment, the updated matrix reflects the final probabilities for each and every candidate message being tested. Candidate messages for which a row is mostly blue, in general, will be eliminated and replaced, assuming there has been sufficient experimental data. Vice versa, a candidate message for which a row is mostly red, in general, will be kept. The row for the control message can be used to select candidate messages for removal (i.e., the “j” candidate messages corresponding to blue squares in the row).

Table 1 below provides an example of adjustments to the initial scores predicted by the reward model 104 the experiment engine 118 made based on success metrics detected during an actual experiment period.

| Test | | Initial | Updated |
|---|---|---|---|
| msg # | Body (test message) | Probability | Probability |
| 0 | Skincare fan? Get ready for some serious glow-up with your new | 0.0487 | 0.06209256987 |
| | {shop.name}} favorites. | | |
| | Limited stock, so don't miss out! | | |
| | Snap yours up now: {{func.last_product_url_viewed(initial_event)}} | | |
| 1 | {shop.name}}: The clock is ticking and our best sellers are flying off | 0.0421 | 0.06394468318 |
| | the shelves. | | |
| | Don't miss out on your top pick: | | |
| | {{func.last_product_url_viewed(initial_event)} | | |
| 2 | {shop.name}}: Want skincare that delivers visible results? We've got | 0.0414 | 0.1222415294 |
| | you covered. Check out the last product you viewed: | | |
| | {func.last_product_url_viewed(initial_event)}} Don't wait, it's selling | | |
| | fast! Plus, enjoy 20% off bundles, free shipping over $65, and hassle- | | |
| | free 30-day returns. | | |
| 3 | Hey, cool cat! [symbol] Want to be the first among your friends to | 0.0413 | 0.05530139246 |
| | experience visible skincare results? Then you better act fast! Your | | |
| | chosen {{shop.name}} product is waiting for you just a click away. | | |
| | Don't miss out, click now: | | |
| | {func.last_product_url_viewed(initial_event)}} | | |
| 4 | Visible results? Count on {{shop.name}}. Grab your new skincare | 0.0385 | 0.06014481263 |
| | favourites at {{func.last_product_url_viewed(initial_event)}} now. | | |
| | Remember: | | |
| | 20% off bundles | | |
| | Free shipping over $65 | | |
| | 30-day returns on us | | |
| | Click through now: {{func.last_product_url_viewed(initial_event)}} | | |
| 5 | {shop.name}}: Ready to level up your skincare game? Your new | 0.0371 | 0.04647106706 |
| | faves are waiting for you. Don't miss out-they're selling fast! Shop | | |
| | now: {{func.last_product_url_viewed(initial_event)}} Enjoy 20% off | | |
| | bundles, free shipping over $65, and easy 30-day returns. Dive in! | | |
| 6 | Hey there! Ready to glow with {{shop.name}}? [symbol] | 0.0322 | 0.04202539751 |
| | We think you'll love {{func.last_product_name_viewed(initial_event)}}. | | |
| | Return to shopping and see the magic: | | |
| | {func.last_product_url_viewed(initial_event)} | | |
| | Don't miss out on 20% off bundles, free shipping over $65, and free | | |
| | 30-day returns! Visit the link now: | | |
| | {func.last_product_url_viewed(initial_event)}} | | |
| 7 | Hey there! [symbol] Ready to see the magic of {shop.name} skincare? | 0.0318 | 0.04662584065 |
| | You're going to love your new products! Don't miss out on bundles at | | |
| | 20% off, free shipping over $65, and free 30-day returns. Finish | | |
| | shopping now: {{func.last_product_url_viewed(initial_event)}} | | |
| 8 | {{shop.name}}: Ready for skincare that delivers visible results? | 0.0315 | 0.05074836894 |
| | Your chosen product's price is likely to rise if you wait. So why delay? | | |
| | Claim it now: {{func.last_product_url_viewed(initial_event)}} | | |
| 9 | Hey, skincare-lover! [symbol] Ready for a beauty upgrade? With | 0.0314 | 0.05661037415 |
| | {shop.name}}, you're just a click away from flawless skin. But don't | | |
| | wait too long - our hottest items are selling out fast! [symbol] Ready to | | |
| | glow? Click here: {{func.last_product_url_viewed(initial_event)} | | |
| 10 | {shop.name}}: Our skincare products are flying off the shelves! If you | 0.0305 | 0.04798782833 |
| | want to see real results, you better act fast. We're down to our last | | |
| | few items, and they won't last long. Grab your favorites now: | | |
| | {func.last_product_url_viewed(initial_event)}} | | |
| 11 | {shop.name}}: Ready to see real results? | 0.0291 | 0.02018702519 |
| | Your new skincare favorites are waiting here: | | |
| | {{func.last_product_url_viewed(initial_event)}} | | |
| | Bundles are 20% off, shipping's free over $65, and returns are free | | |
| | for 30 days. Act fast! | | |
| 12 | Hey you! {{shop.name}} here. | 0.0284 | 0.01647090036 |
| | Craving skincare that truly makes a difference? You're in the right | | |
| | place. | | |
| | But act fast! Our products are flying off the shelves, and we wouldn't | | |
| | want you to miss out. | | |
| | Click quick to grab yours: | | |
| | {{func.last_product_url_viewed(initial_event)}} | | |
| 13 | Hey there! {{shop.name}} here. Ready to elevate your skincare | 0.0284 | 0.01621867595 |
| | game? Your new products are waiting: | | |
| | {func.last_product_url_viewed(initial_event)}} And don't miss out: our | | |
| | bundles are 20% off, we offer free shipping over $65, and have | | |
| | hassle-free 30-day returns. Act fast! | | |
| 14 | Only a few {{func.last_product_name_viewed(initial_event)}} left! | 0.0281 | 0.01458140755 |
| | Grab yours now: {{func.last_product_url_viewed(initial_event)}} Don't | | |
| | miss out: 20% off bundles, free shipping over $65, and free 30-day | | |
| | returns. | | |
| 15 | You want skincare that shows results? {{shop.name}} has what you're | 0.0269 | 0.01759046497 |
| | looking for with {{func.last_product_name_viewed(initial_event)}}. | | |
| | Shop now and enjoy 20% off bundles plus free shipping over $65 and | | |
| | free 30-day returns. Return to shopping: | | |
| | {func.last_product_url_viewed(initial_event)}} | | |
| 16 | You want skincare that works, right? You'll love {{shop.name}}. | 0.0269 | 0.01700545779 |
| | Bundle discounts: 20% off. Free shipping over $65. Free 30-day | | |
| | returns. Shop now: {{func.last_product_url_viewed(initial_event)}} | | |
| 17 | Hey, ready to glow with {{shop.name}}? | 0.0261 | 0.01329864521 |
| | We've got your skincare sorted. Grab your favorite here: | | |
| | {func.last_product_url_viewed(initial_event)} | | |
| | Remember, you get 20% off bundles, free shipping over $65, and | | |
| | free 30-day returns. Don't miss out! | | |
| | 30 days. Don't miss out! | | |
| 18 | Hey there! Ready to see real results? Your new {{shop.name}} | 0.0259 | 0.01539490606 |
| | products are waiting. [symbol] Check them out here: | | |
| | {func.last_product_url_viewed(initial_event)}} | | |
| | Bundles save you 20%, free shipping over $65, and free returns for | | |
| | 30 days. Don't miss out! | | |
| 19 | {shop.name}}: Your {{func.last_product_name_viewed(initial_event)}} | 0.0251 | 0.01552227067 |
| | is popular and going fast! Grab yours before it's gone: | | |
| | {func.last_product_url_viewed(initial_event)}} Remember, bundles | | |
| | are 20% off, free shipping on orders over $65, and you have 30 days | | |
| | to return. | | |
| 20 | {shop.name}}: Ready for skincare that delivers real results? Your | 0.025 | 0.01280263661 |
| | new {{shop.name}} products are waiting for you. Finish shopping | | |
| | here: {func.last_product_url_viewed(initial_event)}} Bundles are 20% | | |
| | off, shipping is free over $65, and returns are free for 30 days. Don't | | |
| | miss out! -Your friends at {{shop.name}} | | |
| 21 | {shop.name}}: Ready for skincare that really works? You'll love what | 0.0249 | 0.01207761045 |
| | we have in store. But don't wait - prices are set to rise soon. So why | | |
| | not grab that deal while you can? Click here to shop now: | | |
| | {func.last_product_url_viewed(initial_event)}} | | |
| 22 | Hey, it's {{shop.name}}. We've got skincare that delivers. And guess | 0.0249 | 0.01525737251 |
| | what? It's all waiting for you right here: | | |
| | {func.last_product_url_viewed(initial_event)}} Quick reminder - our | | |
| | bundles are 20% off, shipping is free on orders over $65, and we've | | |
| | got a 30-day return policy. Happy shopping! | | |
| 23 | Hey, it's your friends at {{shop.name}}. Noticed you eyeing some of | 0.0245 | 0.01252412624 |
| | our products and wanted to let you in on a little secret . . . | | |
| | Click here to continue browsing: | | |
| | {func.last_product_url_viewed(initial_event)} | | |
| | And remember, you can snag 20% off with our bundles, enjoy free | | |
| | shipping over $65, and take advantage of our free 30-day returns. | | |
| 24 | Hey, it's {{shop.name}}! [symbol] Crazy buzz on this one, don't miss out. >> | 0.0238 | 0.01613516592 |
| | {{func.last_product_url_viewed(initial_event)}} And remember, | | |
| | bundles are 20% off, free shipping over $65, and free 30-day returns. | | |
| | Later, skincare aficionado! | | |
| 25 | Hey there! [symbol] Uncover skincare with real results at {{shop.name}}. | 0.0235 | 0.0137191226 |
| | Your next favorite product awaits. Enjoy 20% off bundles and free | | |
| | shipping over $65. Dive back in now: | | |
| | {func.last_product_url_viewed(initial_event)}} | | |
| 26 | Hey there! Your skincare game is about to level up. Seen our | 0.0227 | 0.01081595049 |
| | {shop.name}} goodies yet? [symbol] They're flying off the shelves! Check | | |
| | out your last browse: {{func.last_product_url_viewed(initial_event)}} | | |
| | Quick tip: bundle up for 20% off + enjoy free shipping over $65 and | | |
| | free 30-day returns. Cheers! | | |
| 27 | Hey, it's {{shop.name}}. Remember that product you were eyeing? Its | 0.0217 | 0.01271597232 |
| | price is likely to go up soon, so don't wait too long. Here's the link: | | |
| | {{func.last_product_url_viewed(initial_event)}} | | |
| | Plus, we've got 20% off bundles, free shipping over $65, and 30-day | | |
| | returns. No pressure, just options. | | |
| | Stay radiant, | | |
| | {{shop.name}} | | |
| 28 | {shop.name}}: See the difference our products can make. | 0.0211 | 0.01409175702 |
| | Return to shopping: {{func.last_product_url_viewed(initial_event)} | | |
| | Save 20% on bundles, enjoy free shipping over $65, and shop with | | |
| | confidence with our 30-day free returns. | | |
| 29 | {shop.name}}: Ready to take your skincare game to the next level? | 0.02 | 0.01275409058 |
| | Your new favorites are waiting for you. And heads up: prices are | | |
| | likely to rise soon, so don't miss out. Click here to grab them: | | |
| | {func.last_product_url_viewed(initial_event)}} | | |
| 30 | Hey there! It's {{shop.name}}. | 0.0187 | 0.008831322034 |
| | Ready for skincare that delivers real results? You're going to love | | |
| | what we've got in store for you. | | |
| | Head back to shopping here: | | |
| | {func.last_product_url_viewed(initial_event)}} | | |
| | And remember, our bundles are 20% off, we offer free shipping over | | |
| | $65, and our returns are free for 30 days. | | |
| | {shop.name}}: Ready to see real results? Your new skincare routine | | |
| | is just a click away. | | |
| 31 | Shop now: {{func.last_product_url_viewed(initial_event)}} | 0.0179 | 0.01139068782 |
| | Remember: | | |
| | 20% off bundles | | |
| | Free shipping over $65 | | |
| | 30-day returns on us | | |
| 32 | Hey there, ready for a skincare upgrade? {{shop.name}} products are | 0.0169 | 0.01056646565 |
| | what you need. Remember: bundles are 20% off, free shipping over | | |
| | $65, and free 30-day returns. Catch your last viewed product here: | | |
| | {func.last_product_url_viewed(initial_event)} | | |
| 33 | {shop.name}}: Ready for skincare results you can actually see? | 0.0168 | 0.01071554347 |
| | You'll love our products. Return to shopping here: | | |
| | {func.last_product_url_viewed(initial_event)}} And don't forget: - | | |
| | bundles are 20% off -free shipping over $65 -free 30-day returns | | |
| | Click the link now to shop: | | |
| | {func.last_product_url_viewed(initial_event)}} | | |
| 34 | Eyeing that {{func.last_product_name_viewed(initial_event)}}? You're | 0.016 | 0.007545731033 |
| | not alone. Only a few left now. | | |
| | This is your link back: {{func.last_product_url_viewed(initial_event)}} | | |
| 35 | Hey there, it's {{shop.name}}! | 0.0154 | 0.00982150488 |
| | Ready for skincare that delivers real results? You're going to | | |
| | absolutely love what we've got in store for you. | | |
| | Head back to shopping here: | | |
| | {{func.last_product_url_viewed(initial_event)}} | | |
| | And remember, our bundles are 20% off, we offer free shipping over | | |
| | $65, and all our products come with a free 30-day return policy. | | |
| | Catch you later! | | |
| 36 | {shop.name}}: Ready for skincare that works? Your new favorites are | 0.0148 | 0.00777132240 |
| | waiting. | | |
| | Don't miss out on 20% off bundles, free shipping over $65, and free | | |
| | 30-day returns. | | |
| | Act now: {{func.last_product_url_viewed(initial_event)}} | | |
| 37 | Skincare fan? Get ready for some serious glow-up with your new | 0.0487 | 0.06209256987 |
| | {{shop.name}} favorites. | | |
| | Limited stock, so don't miss out! | | |
| | Snap yours up now: {{func.last_product_url_viewed(initial_event)}} | | |
| 38 | {shop.name}}: The clock is ticking and our best sellers are flying off | 0.0421 | 0.06394468318 |
| | the shelves. | | |
| | Don't miss out on your top pick: | | |
| | {func.last_product_url_viewed(initial_event)} | | |
| 39 | {{shop.name}}: Want skincare that delivers visible results? We've got | 0.0414 | 0.1222415294 |
| | you covered. Check out the last product you viewed: | | |
| | {func.last_product_url_viewed(initial_event)}} Don't wait, it's selling | | |
| | fast! Plus, enjoy 20% off bundles, free shipping over $65, and hassle- | | |
| | free 30-day returns. | | |
| 40 | Hey, cool cat! [symbol] Want to be the first among your friends to | 0.0413 | 0.05530139246 |
| | experience visible skincare results? Then you better act fast! Your | | |
| | chosen {{shop.name}} product is waiting for you just a click away. | | |
| | Don't miss out, click now: | | |
| | {func.last_product_url_viewed(initial_event)}} | | |
| 41 | Visible results? Count on {{shop.name}}. Grab your new skincare | 0.0385 | 0.06014481263 |
| | favourites at {{func.last_product_url_viewed(initial_event)}} now. | | |
| | Remember: | | |
| | 20% off bundles | | |
| | Free shipping over $65 | | |
| | 30-day returns on us | | |
| | Click through now: {{func.last_product_url_viewed(initial_event)}} | | |
| 42 | {{shop.name}}: Ready to level up your skincare game? Your new | 0.0371 | 0.04647106706 |
| | faves are waiting for you. Don't miss out-they're selling fast! Shop | | |
| | now: {{func.last_product_url_viewed(initial_event)}} Enjoy 20% off | | |
| | bundles, free shipping over $65, and easy 30-day returns. Dive in! | | |
| 43 | Hey there! Ready to glow with {{shop.name}}? | 0.0322 | 0.04202539751 |
| | We think you'll love {{func.last_product_name_viewed(initial_event)}}. | | |
| | Return to shopping and see the magic: | | |
| | {func.last_product_url_viewed(initial_event)}} | | |
| | Don't miss out on 20% off bundles, free shipping over $65, and free | | |
| | 30-day returns! Visit the link now: | | |
| | {func.last_product_url_viewed(initial_event)}} | | |
| 44 | Hey there! [symbol] Ready to see the magic of {{shop.name}} skincare? | 0.0318 | 0.04662584065 |
| | You're going to love your new products! Don't miss out on bundles at | | |
| | 20% off, free shipping over $65, and free 30-day returns. Finish | | |
| | shopping now: {{func.last_product_url_viewed(initial_event)}} | | |
| 45 | {shop.name}}: Ready for skincare that delivers visible results? | 0.0315 | 0.05074836894 |
| | Your chosen product's price is likely to rise if you wait. So why delay? | | |
| | Claim it now: {{func.last_product_url_viewed(initial_event)}} | | |
| 46 | Hey, skincare-lover! [symbol] Ready for a beauty upgrade? With | 0.0314 | 0.05661037415 |
| | {{shop.name}}, you're just a click away from flawless skin. But don't | | |
| | wait too long - our hottest items are selling out fast! [symbol] Ready to | | |
| | glow? Click here: {{func.last_product_url_viewed(initial_event)}} | | |

At the end of an evaluation period, the adjusted scores are logged and then aggregated into the training data sets (step 412). The experiment is continuously running while a marketing campaign is active. As noted above, the system 100 can work in conjunction with campaign system 120, in which case the system 100 provides candidate messages to the campaign system 100 to send out to prospective subscribers and shoppers under the traffic allocation determined by the experiment engine 118. During this time, the system 100 continuously introduces and tests new candidate messages, which is necessary because what messages are best received by the target audience usually change over time. The system 100 iterates with each set of test messages and evaluates them. The evaluation period for each iteration usually varies between one to five weeks, depending on the data volume. For the reward model 104, the updated training dataset improves its performance at predicting continuation text effectiveness for the assigned tasks of marketing and sales. For the policy model 102, the updated training dataset improves and stabilizes its performance at generating continuation texts that are context appropriate, garner positive sentiments, and motivates positive business outcomes. For the prompt engine 108, the updated training dataset improves its ability to generate better prompts for the policy model 102.

Note that the introduction of a new merchant to the system 100 requires adaptation of the above described process because of cold-start related problems. Specifically, the reward model 104 does not have any relative preference data for the new merchant and so will not perform its function of predicting scores for candidate messages optimally until sufficient preference data can be obtained. However waiting for sufficient training data may not be an option, in which case the system 100 can bypass the wait by leveraging existing relative preference data (data obtained before the new merchant was introduced) and a feedback loop based on success metrics, both of which ensures adequate reward model performance such that it can predict and provide, to the new merchant, candidate messages that, more likely than not, out perform the baseline message that the merchant has been using.

Specifically, the system 100 constrains the reward model 104, which has been trained with global relative preference data, to predict that a given candidate message would perform up to 20% better or worse than a corresponding control message. Alternatively, there are no constraints on the reward model 104, and the system 100 simply adjusts the scores outputted by the reward model 104 proportionally so that they span only in the range of being 20% better or worse than the control message. The system 100 then concocts 500 phantom data points that reflect the predictions. For example, if the reward model 104 predicts a 5% conversion rate for a candidate message, then the 500 phantom data points are assumed to have 25 positive outcomes. Suitable traffic allocation here is 50% for the control message and 50% for the candidate messages to share based on their scores.

When actual experimental data is obtained, then the system 100 appends the phantom data points with the actual data points. For example, the system 100 collects 1000 real data points with 52 positive outcomes for the candidate message, the tally is now 77 positive outcomes over 1500 data points. Optionally, the appending process applies a beta-binomial conjugate algorithm. Other Bayesian analyses can be suitable and used in lieu to update posterior probabilities and distributions, e.g., normal-gamma and gamma-Poisson distributions.

Advantageously, the system 100 effectuates a lift in the performance of the marketing campaign over the control message, and more subscriptions and/or purchases are realized. This lift is accomplished by the system 100's constant iteration to determine and select the higher performing continuing texts based on empirical data (i.e., the relative preference data), rather than survey data. Moreover, a campaign of a new merchant can start without having to wait for the system 100 to obtain relative preference data, even when the reward model 104 has not been trained with relative preference data for the new merchant. Predictions from the reward model 104 that is trained with global relative preference data are sufficient to start, even when they are not optimized, because the system 100 can dynamically allocate traffic to higher performing candidate messages based on a live feedback loop based on success metrics. Figuratively speaking, the system 100 makes a best guess based on what it has learned from historical data and constantly tweaks its guesses based on what it detects during the course of a campaign.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

Machine learning models can be transformer-based, which in turn can be a large language model (LLM).

A computer program can be written in any form of programming language, including compiled or interpreted languages, or declarative or procedural languages; and it can be deployed in any form, including as a stand-alone program, e.g., as an app, or as a software module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or microcontrollers or a combination of them, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. However, a computer need not have such devices. Moreover, a computer can be embedded in another device, e.g., a mobile telephone, a personal digital assistant (PDA), a mobile audio or video player, a game console, a Global Positioning system (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., on a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system for generating continuing texts, comprising:
a policy model configured to generate one or more candidate messages, given a baseline message and corresponding policies, wherein the candidate messages are generated under constraints imposed by the policy;
a reward model trained to predict a performance of the candidate messages generated by the policy model relative to the control message, wherein training is accomplished with relative engagement data; and
one or more servers having tangibly-stored instructions executable to:
prompt the policy model to generate candidate messages for new content being introduced to the system in reference to a control message associated with the new content, wherein the system has yet to obtain relative preference data associated with the new content, and wherein the reward model has not been trained with relative preference data associated with the new content;
cause the reward model to predict a performance of at least one of the candidate messages for the new content against the control message associated with the new content and concocting phantom relative preference data that are based on the predicted performance;
test the candidate messages to obtain actual relative preference data obtained from human user engagements with the candidates messages being tested;
supplement the phantom relative preference data with real relative preference data; and
select candidate messages to send as continuing text, whereby reward model performance is sufficiently improved with the real relative preference data to compensate for its lack of training with relative preference data associated with the new content such that the selected candidate message is more likely than not to out perform the control message.

2. The system of claim 1, wherein the policy model is trained with relative preference data, and wherein the relative preference data is a suitable proxy for survey data and is used in lieu of survey data.

3. The system of claim 1, wherein the one or more servers further comprise tangibly-stored instructions executable to prompt a transformer-based machine learning model to generate a prompt for input to the policy model, wherein the prompt causes the policy model to generate candidate messages.

4. The system of claim 1, wherein the relative preference data comprises data that indicates a preference of one continuing text over one or more other continuing texts.

5. The system of claim 4, wherein the relative preference data comprises one or more success metrics that indicate the relative success of one continuing text over one or more other continuing texts.

6. The system of claim 1, wherein the instructions are further executable to perform operations comprising:
adjusting scores predicted by the reward model; and
rebalancing allocation of traffic of candidate messages based on adjusted scores.

7. The system of claim 6, wherein the operations further comprise removing candidate messages not satisfying a performance metric threshold, and obtaining from the policy model new candidate messages to replace the candidate messages that have been removed.
